(19) United States
(12) Patent Application Publication
(10) Pub. No.: US 2018/0345507 A1
(43) Pub. Date: Dec. 6, 2018

(54) Brush cuttier blade

(71) Applicant: Gaylord Carter, (US)

(72) Inventor: Gaylord Mathew Carter, Springfield, OR (US)

(21) Appl. No.: 15/731,335

(22) Filed: May 30, 2017

(51) Int. Cl. B26B 3/04; B26B 9/02; B26B 1/02

(52) U.S. Cl. CPC B26B 3/04; B26B 1/02; B26B 9/02

(57) ABSTRACT

Living in the Northwest it is nearly impossible to own land and not wage war against invasive blackberries and brush. While attempting to fight this battle with a regular single blade trimmer attachment, it dawned on me that the real trouble is that a single cut only detaches the plant from its base, but leaves it suspended in neighboring brush. My invention with its multiple planes of bladelets turns the brush immediately to mulch for easy raking or to leave as mulch.

### CROSS REFERENCE TO RELATED APPLICATION

None

### STATEMENT REGARDING FEDERALLY SPONSORED RESEARCH OR DEVELOPMENT

none

### REFERENCE TO A SEQUENCE LISTING

None

### BACKGROUND OF INVENTION

Prior to my invention of this blade, the state-of-the-art technology for blackberry removal included various single plane cutting blades of different types and large complicated blades not suitable for smaller trimmers nor easily manufactured. It was clear that something new was needed. Previously available technologies only provided one cutting plane to unwanted brush creating further need for a very difficult clean-up.

### BRIEF SUMMARY OF INVENTION

I constructed this multiple planed cutting blade to be able to cut blackberries and other suitable plants on the side stroke, down stroke and up stroke of the brush cutter. Taking multiple cuts per rotation mulches blackberries and other suitable vegetation. My trimmer attachment mulches unwanted vegetation for easy raking up or leaving in place as mulch, as the user sees fit.

### DESCRIPTION OF DRAWING

Figure one is top view of invention showing the center hole for placement on the arbor of the trimmer and the splits that enable the blade to be separated into two bladelets on different planes which are sharpened on their cutting edges.

Figure two is a drawing of the side view of the invention showing the ninety degree separation of the bladelets described in the previous explanation.

### DESCRIPTION OF INVENTION

The invention is manufactured by taking an approximate 8″×2″×⅛″ suitable piece of steel, placing a 1″ diameter hole in the exact center for balance, drilling two ¼″ relief holes 1″ from each end in exact center, and placing a cut down center of both ends of blade up to the relief hole. This creates the 1″×1″ bladelets that are radius-bent to approximately forty-five degrees from the plane of the original blade both up and down creating a ninety degree deflection from each other. Bladelets are then sharpened on both sides to make the blade reversible. To use, install as any ordinary trimmer blade.

### DESCRIPTION OF DRAWINGS FOR APPLICATION SER. NO. 15/731,335

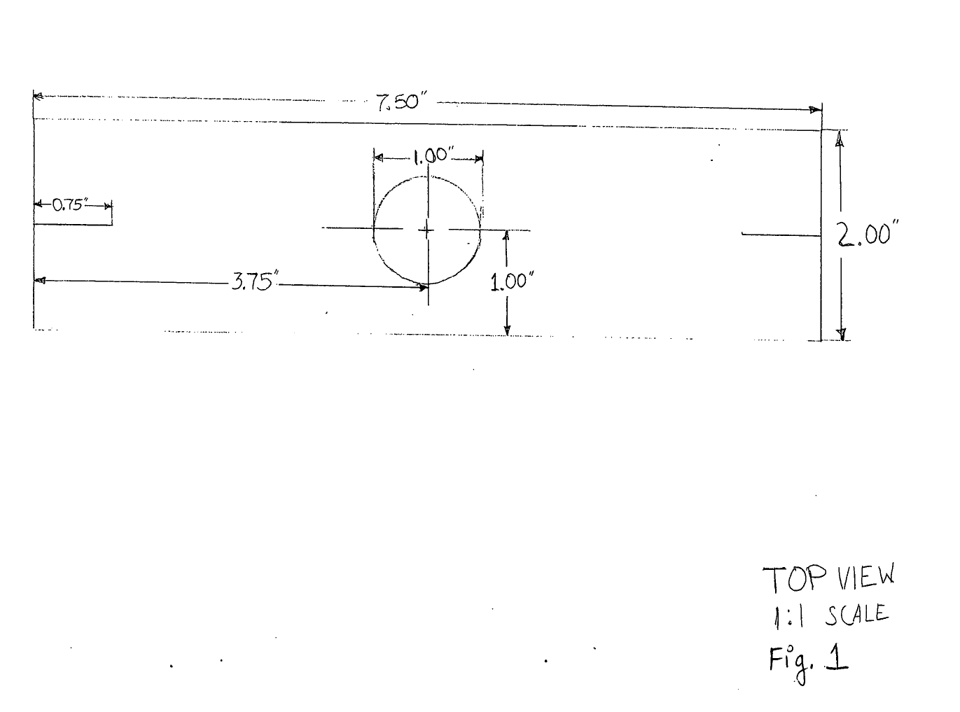

FIG. 1: top view of blackberry mulcher blade

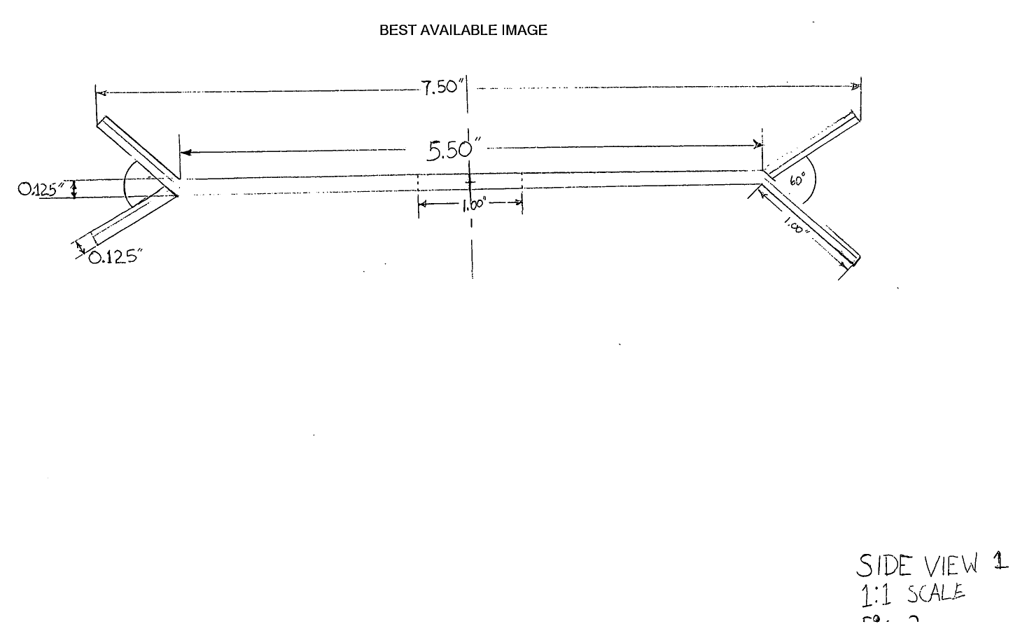

FIG. 2: side view of blackberry mulcher blade

1: A reversible blade comprising a plurality of spaced apart blades formed integrally with a central portion, the central portion having an opening, each blade of the plurality of spaced apart blades having a leading edge and a trailing edge with the leading edge being curved towards the trailing edge.

2: The reversible blade of claim 1 wherein the blade is composed of a single sheet of metal.
